(19) United States
(12) Patent Application Publication
(10) Pub. No.: US 2002/0120748 A1
(43) Pub. Date: Aug. 29, 2002

(54) Method and apparatus for selective delivery and forwarding of electronic mail

(76) Inventors: Vincent J. Schiavone, Berwyn, PA (US); James H. Koenig, Philadelphia, PA (US); Cedarampattu Mohan, Yardley, PA (US)

Correspondence Address: Gregory S. Bernabeo, Esquire, Synnestvedt & Lechner LLP, 2600 Aramark Tower, 1101 Market Street, Philadelphia, PA, 19107-2950, US

(21) Appl. No.: 09/793,296

(22) Filed: Feb. 26, 2001

(51) Int. Cl. G06F 15/16

(52) U.S. Cl. 709/227

(57) ABSTRACT

A method for selectively delivering and forwarding electronic mail messages. A user having a certain electronic mailbox for receiving electronic mail messages provides an alternate electronic mail address of an alternate electronic mailbox. Criteria is established for determining whether an e-mail message addressed for delivery to the certain electronic mailbox will be delivered to that mailbox or forwarded to the alternate electronic mail address. The method is implemented by mail routing software running on a mail server. The mail routing software forwards mail messages meeting the criteria without delivering them to the electronic mailbox to which they were addressed. The method thereby lessens the burdens on the electronic mail system servicing the certain electronic mailbox and prevents delivery of inappropriate messages to the certain electronic mailbox while permitting retrieval of such messages via an alternate electronic mailbox. An apparatus for carrying out the inventive method is also provided.

### FIELD OF THE INVENTION

This invention relates generally to the field of electronic mail and particularly to a method and apparatus for selective distribution of electronic mail.

### BACKGROUND OF THE INVENTION

Communications networks, such as the Internet, are now being widely used internationally for sending and receiving electronic mail (“e-mail”) messages. While e-mail has long been used for personal matters, it is now being heavily used for customer relationship management (“CRM”), marketing and/or other commercial (collectively “commercial”) purposes. In a report titled “E-mail Marketing—Closing the Loop from Acquisition to Retention”, Jupiter Communications forecasts that the number of unique e-mail marketing messages will grow from three billion in 1999 to 268 billion in 2005. The reach of commercial e-mail is often overly broad because e-mail is quickly, easily and inexpensively sent. As a result, many individual e-mail users receive unwanted, unsolicited bulk e-mail typically referred to as “spam”. While a small amount of spam may be merely a minor annoyance to a user, a large amount of spam can be overwhelming, time-consuming to deal with, and extremely aggravating to the user, and burdensome on the communications network infrastructure.

E-mail messaging is also widely used for business-related or organization-related (collectively, “corporate”) communications. In many corporations, for example, nearly all employees are provided with an electronic “mailbox” for receiving corporate e-mail messages. The electronic mailbox has an electronic mail address serviced and maintained by one or more mail server computers of the corporation's computer network. An electronic mail address, as used herein, is an alphanumeric string which is usable in an electronic mail system to deliver an electronic mail message to one or more electronic mailboxes and/or devices configured to receive electronic mail messages addressed to one or more of such addresses. An electronic mailbox is basically an allocation of the mail server's hard disk space for storing a user's incoming and outgoing e-mail. The mail server stores and runs mail server software for processing incoming and outgoing mail. Computer hardware and software for operating an e-mail system are well known in the art.

A simplified explanation of the operation of a typical e-mail system is as follows: an incoming mail message directed to a mail server is received into the mail server's incoming message queue. Mail server software running on the mail server examines header information contained in the mail message and, if the message is addressed to a user's e-mail address which is supported by the mail server, the mail server “delivers” the mail to the user's mailbox. In other words, the mail server stores the mail message in a file (or appends it to a file) or in a mail directory on the mail server's hard disk. Even for a moderate number of users, a significant amount of mail server storage space is required. The user may then retrieve the mail messages from the user's mailbox and view the mail message using mail reader/mail client software, e.g. Microsoft Outlook, stored and running on the user's computer.

In addition to the corporate messages that are welcomed by the employer, many personal and commercial e-mail messages are directed and delivered to an employee's business e-mail address. The receipt, distribution and storage of personal and commercial e-mail messages create a heavy and unnecessary burden on an organization's e-mail systems, requiring additional bandwidth, mail servers and mail storage capacity, all of which are expensive to obtain and maintain. The processing of personal and commercial messages may cause the organization's e-mail system to operate slowly, and corporate communications to be delayed.

Various methods, computer hardware and software exist for automated copying and/or forwarding of e-mail messages. Under existing methods, all e-mail messages sent to a certain e-mail address are either: (1) delivered to the associated mailbox with a copy being forwarded to an alternate e-mail address; or (2) never delivered to the associated mailbox but rather forwarded to an alternate e-mail address and delivered only to the alternate mailbox associated with the alternate e-mail address. Such existing practices are insufficient to resolve the problems discussed above, in part because either all messages reach the mail server and the mail client and therefore burden the network or because no messages reach the mail client (although they may reach the mail server), i.e, no corporate e-mail is delivered to the corporate mailbox.

U.S. Pat. No. 6,138,146 to Moon et al. discloses a system for selective forwarding of e-mail messages from a private network mail system. Private network mail messages are typically readable only from a private network computer because a public network firewall and/or other security measures prevent direct access of a private network from a public network. However, a private network client computer/workstation is typically capable of sending and receiving public network mail as well as private network mail. Moon teaches the running of a mail forwarding program on the private network client computer. Once a private network mail message is received at the client computer, the mail forwarding program retransmits the message to a public network e-mail address where they are stored on a mail server accessible via the public network. This is useful, for example, to permit a traveling business person (“TBP”) to view from a remote location e-mail messages received at a corporate mailbox on the TBP's work computer by having such messages retransmitted to an Internet-accessible mailbox, such as a World Wide Web, e.g., a Yahoo!, e-mail account. The TBP can then retrieve the e-mail messages from any remote location where public network, e.g., Internet, access is available. This may be done for all incoming messages while the forwarding software is “on”, or selectively, e.g., based on a sender identity, message topic, billing account number, etc. Because all e-mail messages must be received at the client computer and certain messages are retransmitted via the private network, this still places significant burdens on the private network.

### SUMMARY OF THE INVENTION

The present invention provides a method and apparatus for selectively delivering and forwarding electronic mail messages. Using the present invention, criteria is established for determining whether an e-mail message addressed for delivery to a user's primary mailbox will be delivered to the user's primary mailbox or to a secondary mailbox of the user. In some embodiments, the mail messages are delivered to one or more mailboxes, which may include mailboxes accessible via a general-purpose computer, a web-enabled wireless telephone, a text-based messaging device, an instant messaging device and/or a wireless personal digital assistant device, such as a Palm VII® device. In this manner, for example, an employer can permit only business-related e-mail messages to be delivered to the employee's employer-provided mailbox, and cause all other e-mail messages addressed to the employee's employer-provided e-mail address to be forwarded to the employee's personal e-mail address and thus to be stored at a mail server other than the employer's mail server. Accordingly, e-mail messages are both selectively delivered and selectively forwarded.

Preferably, the method is implemented by mail routing software running on a mail server servicing a user's primary mailbox. The mail routing software forwards a first subset of messages to the secondary address and delivers only a second subset of messages to the primary mailbox. In the preferred embodiment, the primary and secondary mailboxes are serviced by different mail servers in different mail domains (e.g., one e-mail address may be provided by the recipient's employer and serviced in a business domain and another e-mail address may be a personal account serviced by an entirely unrelated ISP or ESP). As used herein, a “subset” of messages is fewer than all messages. Accordingly, the first subset of messages need not be received at the employee's work computer. This prevents employees from being distracted by non-corporate e-mail and helps protect corporations from any of the risks and indirect liability for employee redistribution of illicit or otherwise inappropriate content. The inventive method lessens the burden on and the required capacity of the employer's e-mail system, allowing business-related messages to be processed efficiently and expeditiously.

### DESCRIPTION OF THE DRAWINGS

FIG. 1 is a flow diagram of an exemplary selective mail delivery transaction in accordance with one embodiment of the present invention, shown from a user's perspective;

FIG. 2 is a flow diagram of the transaction of FIG. 1, shown from a routing authority's perspective; and

FIG. 3 is a block diagram of a routing authority's mail server computer in accordance with the present invention.

### DETAILED DESCRIPTION

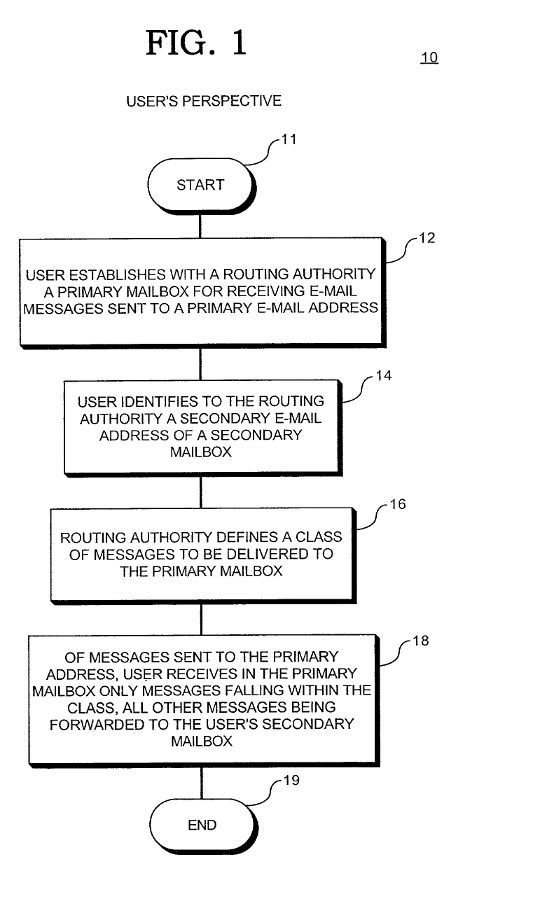

FIG. 1 is a flow diagram 10 of an exemplary selective mail delivery transaction in accordance with one embodiment of the present invention, shown from a user's perspective. As shown in FIG. 1, the method starts with the user's establishment of a primary mailbox with a routing authority, i.e., an entity performing a selective mail routing function, as shown at steps 11 and 12. Preferably, the routing authority operates the mail server servicing the primary mailbox. The primary mailbox is configured for receiving e-mail messages sent to a primary e-mail address. For example, a user may establish an electronic mailbox by completing employment application forms required by an employer (which is used by an computer professional to create a mail account) or by providing requested information via a computer terminal. Computer hardware and software for establishing electronic mailboxes and for using and maintaining electronic mail systems are well known in the art and are not discussed at length herein.

An Internet e-mail address typically has the form userid@mail_server.domain_name where userid is the user's username. For illustrative purposes, an example is discussed below in which the user is Joe Smith and the routing authority is Joe Smith's employer, Employer, Inc. The electronic mailbox established for Joe Smith is associated with, i.e., has, an electronic mail address of joesmith@employer.com. This is Joe Smith's primary e-mail address. This primary mailbox is serviced by Employer Inc.'s mail server(s).

The user also provides to the routing authority a secondary e-mail address of a secondary mailbox, as shown at step 14. In this example, Joe Smith's secondary mailbox is a personal mailbox established with Personal Mail, Inc., a free Web-based e-mail service, and serviced by Personal Mail, Inc.'s mail server(s). The secondary mailbox has a secondary e-mail address of joesmith@personalmail.com.

The routing authority defines a class of messages deliverable to the primary mailbox, as shown at step 16. In this example, Employer, Inc. intends that Joe Smith use the employer-provided (primary) e-mail address for business-related e-mail messages only. Accordingly, Employer, Inc. defines a “business-related” class to include any message having the term “business related” in its header information. In an alternate embodiment, the user is permitted to define the class.

Of the messages sent to the primary address, e.g., those messages addressed to the primary address, the user receives in the primary mailbox only those messages falling within the defined class, as shown at step 18. All other messages are forwarded to the user's secondary e-mail address for delivery to the user's secondary mailbox. The transaction then ends, as shown at step 19. In other words, a message's message characteristic is compared to routing criteria to determine how to route the mail. For example, routing criteria could specify that for a certain user, all messages containing a certain term be delivered to a certain mailbox and all other messages be forwarded to a certain e-mail address.

In this example, a message addressed to joesmith@employer.com and containing the term “business related” in the header information is delivered to Joe Smith's primary mailbox and will be viewable by Joe Smith when he checks for messages in his primary mailbox using mail reader software. A message addressed to joesmith@employer.com which does not contain the term “business related” in its header information is forwarded to Joe Smith's secondary e-mail address and will be viewable by Joe Smith when he checks for messages in his secondary mailbox using mail reader software.

The example of FIG. 1 is referred to herein as an “opt-in” method. In other words, either the user or the routing authority defines a class of messages that will be delivered to the primary mailbox. In an alternate embodiment, an “opt-out” method is used. In an “opt-out” method, either the user or the routing authority defines a class of messages that will not be delivered to the primary mailbox. A corporate domain can preconfigure certain permissible addresses and domains.

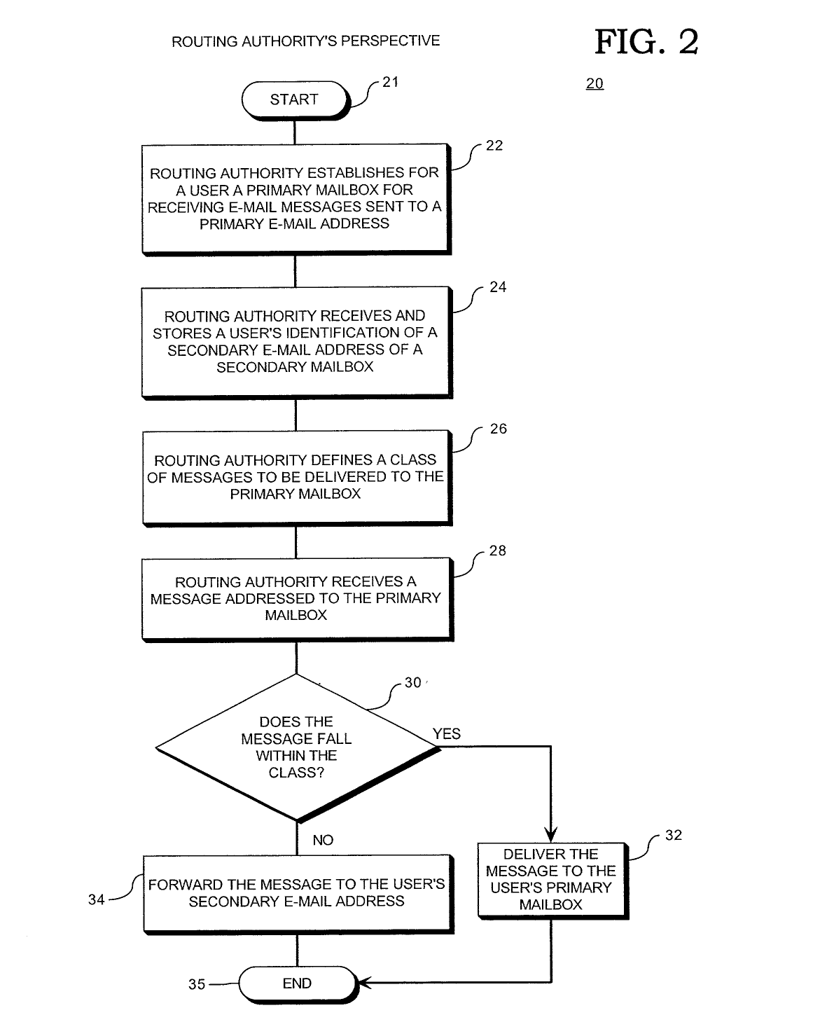

FIG. 2 is a flow diagram 20 of the transaction of FIG. 1, shown from a routing authority's perspective. As shown in FIG. 2, the method starts with the routing authority's establishment of a primary mailbox for a user, as shown at steps 21 and 22. The primary mailbox is serviced by the routing authority's mail server and is configured to receive e-mail messages sent to a primary e-mail address. In other words the routing authority's mail server computer(s) run mail server software configured for delivering e-mail to the primary e-mail address.

The routing authority receives and stores identification of a user's secondary e-mail address, as shown at step 24. For example, the secondary e-mail address may be supplied by the user and such information may be stored in a user address database on a hard disk storage device of the routing authority's mail server.

The routing authority next defines a class of messages to be accepted for delivery to the primary mailbox, as shown at step 26. There are various ways to define a class of messages. Essentially, the class is defined to include messages having a certain message characteristic. U.S. Pat. No. 6,138,146 to Moon et al., the disclosure of which is incorporated herein by reference, discusses criteria for classifying a message. In one embodiment, the routing authority or the user may define a class to include messages having certain senders, certain topics (keywords), certain billing codes, etc. In such an embodiment, the routing authority stores such information in a class definition database. For example, the routing authority could store the term “fiber optic” in a class definition database as a keyword associated with the “business related” class. In this approach, an attempt is made to associate a message with defined class. This approach does not require any special activity on the part of the sender, but rather acts somewhat like a mail filter.

In another embodiment, the class is defined to include a certain class identifier, where the sender specifies a certain class for a message by including the certain class identifier in the message. The class identifier may be defined by the sender, routing authority or user. For example, the sender may specify a class for a message by including a class identifier within the body of the message text, within displayable header information of the message, e.g., within the Subject field, or within a hidden, special field of the header information which may be added and/or populated by the sender. In this approach, the sender and receiver have agreed to use certain class identifier nomenclature. Any other suitable method of classifying messages may be used.

In the illustrative example discussed above, the primary mailbox has an electronic mail address of joesmith@employer.com and the routing authority receives and stores Joe Smith's secondary e-mail address, namely joesmith@personalmail.com. The routing authority has defined a “business-related” class of messages as messages that include the class identifier “business-related” in their header information. The routing authority therefore stores such class definition data in a class definition database.

As shown at step 28 of FIG. 2, the routing authority next receives a message addressed for delivery to the primary mailbox, e.g., addressed to the primary mailbox. More specifically, the message is received via a communications network, such as the Internet, into an incoming message queue of the routing authority's mail server(s). Incoming message queues are well known in electronic mail systems, e.g., those using Post Office Protocol, such as POP3, or IMAP4 protocol.

To illustrate the example of FIG. 1, consider two separate messages received in step 28. Both messages are addressed to joesmith@employer.com. The first message is a business-related communication from Joe Smith's supervisor, Sam Supervisor, and it contains the term “business-related” in its header information. The second message is a personal communication from Joe Smith's cousin, Jack Smith, and it does not contain the term “business-related” in its header information.

Next, because this example is an opt-in system, it is determined whether the incoming message falls within the class, as shown at step 30. This is determined by inventive mail routing software running on the routing authority's mail server. The inventive mail routing software is configured to permit delivery to the primary mailbox of only a certain subset of messages sent to the primary e-mail address. The inventive mail routing software effectively acts as a comparator, to compare message characteristics of incoming mail messages to message characteristic criteria, e.g., class definitions. The inventive mail routing software initiates either delivery of the message to the intended mailbox or forwarding of the message to an alternate electronic mail address, e.g., one retrieved from a user address database. The delivery and forwarding processes may be accomplished using conventional hardware, software and techniques that are not the subject of the present invention. Various programming techniques for implementing the mail routing software are well known in the art.

The mail routing software first references a class definition database to identify characteristics associated with the defined class. The mail routing software then examines the incoming message received in the mail server's message queue and searches for such message characteristics, e.g. certain specifiers, keywords or other terms or codes, to determine whether an incoming message falls within the class. When a characteristic of the message matches characteristics of the class stored in the class definition database, the message is considered to be a member of the respective class.

In the illustrative example, the mail routing software identifies the term “business-related” as a class identifier. It next examines incoming messages in the message queue and looks for the “business related” class identifier in its header information, the message is considered a member of the “business related” class.

If the class identifier is found, the message falls within the specified class and the message is delivered to the user's primary mailbox, as shown at step 32, and the transaction ends, as shown at step 35.

In the illustrative example, the first message from Sam Supervisor is determined to fall within the class in step 30 because it contains the term “business-related” in its header information. Accordingly, the first message is delivered to Joe Smith's primary mailbox in step 32. For example, the mail handling software stores the incoming mail message in a mail folder/directory on the mail server which is accessible by the user's mail reader (mail client) software running on the user's computer. The message may subsequently be retrieved by the user, listed in an “inbox” of the mail reader software, and displayed to the user by the mail reader software. The delivery step may be performed in any suitable manner and many suitable manners are known in the art.

If the message does not contain the class identifier, it does not fall within the class. Accordingly, the mail message is forwarded to the user's secondary e-mail address, as shown at step 34, and the transaction ends, as shown at step 35. Specifically, the mail routing software references its user address database and identifies the secondary e-mail address for the user. The mail message is subsequently forwarded to the secondary e-mail address using any suitable mail forwarding methodology, many of which are well known in the art. For example, the mail is simply retransmitted from the mail server to the secondary e-mail address. In accordance with the present invention, a mail message falling outside the class (or within the class in an opt-out embodiment) is never deposited in the user's primary mailbox and, depending on the configuration, may never be deposited on the corporate server. This lessens the burden on the corporate network, corporate computers, and prevents distraction of employees by non-work related e-mail messages. It also helps to preserve the privacy of personal e-mail communications.

In the illustrative example, the second e-mail message from Jack Smith does not contain the term “business-related” in its header information and so is determined to fall outside the class in step 30. Thus, the second message is forwarded by Employer, Inc.'s mail server to Joe Smith's secondary mailbox at joesmith@personalmail.com, as shown at step 34.

In accordance with the present invention, therefore, a first subset of messages addressed for delivery to the primary mailbox are delivered to the primary mailbox and a second subset of messages addressed for delivery to the primary mailbox are forwarded to a secondary mailbox. Preferably a message's membership in the first or second subset is mutually exclusive, such that the second subset is a remaining subset of all messages not contained within the first subset.

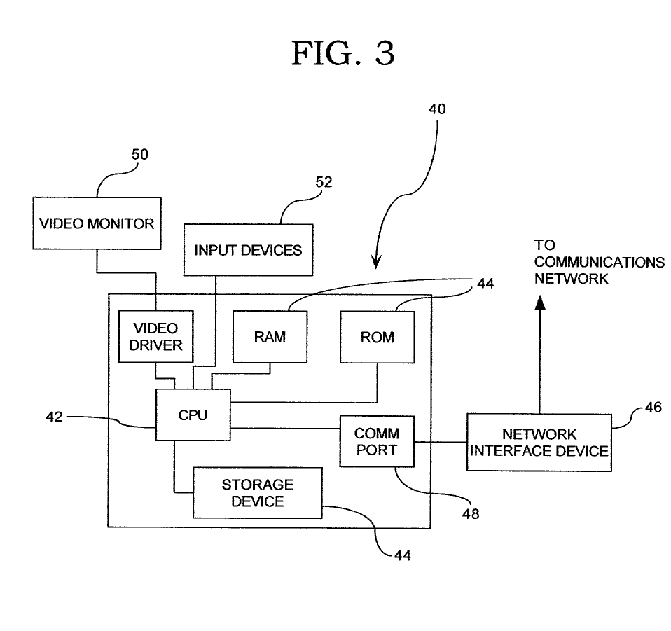

The method of the present invention may be implemented through the use of one or more computers having typical hardware and/or specially configured software. FIG. 3 is a block diagram of a routing authority's mail server computer 40 in accordance with the present invention. The hardware of the mail server is of a type generally known in the art. The mail server 40 includes a central processing unit (“CPU”) 42, a memory 44, e.g., random access memory (“RAM”), read only memory (“ROM”) and/or a storage device such as a hard disk drive, and a telecommunications device 46 for communicating via a communications network, e.g., using TCP/IP technology. The telecommunications device may include a modem and/or a network card connected via a communications port 48. The mail server 40 may optionally include a video display device 50 and/or input devices 52.

The mail server 40 stores in its memory CPU-executable programs including a first program for forwarding a first subset of said messages to an alternate electronic mail address and a second program for delivering a second subset of said messages to said mailbox.

Optionally, the mail server 40 may also store in its memory a third program for receiving an electronic mail message addressed for delivery to said electronic mailbox, a fourth program for identifying a message characteristic associated with said mail message, a fifth program for comparing said message characteristic to routing criteria, and a sixth program for delivering said message to said mailbox or forwarding said message to said alternate electronic mail address as specified by said routing criteria.

A sender or recipient may use any suitable form of communications device known in the art, including a Web-enabled wireless telephone, a wireless personal digital assistant such as a Palm VII® device, an instant message-enabled device, a pager, etc.

It is noted that the present invention may be advantageously combined with a dynamic prioritization system and/or categorization system such as that disclosed in U.S. application Ser. No. ______ titled Method And Apparatus For Dynamic Prioritization of Electronic Mail Messages (Attorney Docket No. P24773 USA), filed ______, now U.S. Pat. No. ______, issued ______, for example, using the class identifier embedded in the message in accordance with the present invention to display the message in an appropriate section of a categorized inbox—for example, using class identifiers of “personal”, “business”, “customer relations”, “commercial” corresponding to “personal”, “business”, “customer relations”, and “commercial” sections of an inbox. Messages without a class identifier may be displayed in a “bulk” or “unclassified” default category.

It should be noted that the secondary electronic mail address may be an electronic mail address for messages receivable via a wireless and/or mobile device, including a Web-enabled or text-based messaging wireless telephone, a wireless personal digital assistant such as a Palm VII® device, an instant message-enabled device, a pager, etc.

It should also be noted that instead of rerouting to a secondary electronic mail address all messages addressed to a primary electronic mail address, the routing authority may be configured to send a copy of a message and/or a notification message to at least one of a secondary address or additional addresses. Optionally, this may be performed for every incoming message or only for messages falling within a certain class, e.g., messages selected as a function of the sender's identity or e-mail address (e.g. all messages from joe@yahoo.com are forwarded to mike@aol.com), the class identifier (e.g. all messages having a COMMERCIAL class identifier are sent to a pager address) and/or other content (e.g., based on certain keywords) (e.g. all messages containing keyword WEBCENTRIX are sent to a pager address). This is particularly useful if the secondary address is for messages deliverable to a pager, e.g., when certain messages are urgent and must be received regardless of where the recipient is or what the recipient is doing at the time the message is received.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for distributing electronic mail messages addressed for delivery to an electronic mail address of an electronic mailbox, said method comprising:
(a) forwarding a first subset of said messages to an alternate electronic mail address; and
(b) delivering a second subset of said messages to said mailbox.

2. The method of claim 1, wherein said second subset comprises a remaining subset of said messages.

3. The method of claim 1, wherein said electronic mail address is associated a first mail server and wherein said alternate electronic mail address is associated with a second mail server.

4. The method of claim 1, further comprising the steps of:
(c) establishing an electronic mail account for a user, said account providing an electronic mailbox having an associated electronic mail address;
step (c) being performed before step (a).

5. The method of claim 1, further comprising the steps of:
(d) receiving an electronic mail message addressed for delivery to said electronic mailbox;
(e) identifying a message characteristic associated with said mail message;
(f) comparing said message characteristic to routing criteria; and
(g) delivering said message to said mailbox or forwarding said message to said alternate electronic mail address as specified by said routing criteria.

6. The method of claim 5, wherein said routing criteria is established by a routing authority.

7. The method of claim 5, wherein said routing criteria is established by a user.

8. The method of claim 5, wherein step (d) comprises receiving said message into an incoming message queue of a mail server.

9. The method of claim 5, wherein step (e) comprises searching header information associated with said message.

10. The method of claim 9, wherein step (e) comprises identifying sender information.

11. The method of claim 9, wherein step (e) comprises identifying a classification established by said sender and associated with said message.

12. The method of claim 9, wherein said classification is included in header information of said message.

13. The method of claim 5, wherein step (f) comprises referencing a database of routing criteria.

14. The method of claim 5, wherein the delivering step of step (g) comprises storing said message on a mail server for retrieval via a user's mail client software.

15. The method of claim 5, wherein the delivering step of step (g) comprises transmitting said message to a user's computer.

16. The method of claim 5, wherein the delivering step of step (g) comprises causing said message to be displayed to a user via said user's computer.

17. The method of claim 5, wherein the forwarding step of step (g) comprises transmitting said message to said alternate electronic mail address.

18. The method of claim 5, further comprising the step of:
(h) receiving identification of said alternate electronic mail address.

19. The method of claim 18, wherein said identification is received in step (h) via a communications network.

20. A method for distributing electronic mail messages addressed to an electronic mail address of an electronic mailbox, said method comprising:
(a) establishing an electronic mail account for a user, said account providing an electronic mailbox having an associated electronic mail address;
(b) storing an alternate electronic mail address for a user;
(c) receiving an electronic mail message addressed for delivery to said electronic mailbox;
(d) identifying a message characteristic associated with said mail message;
(e) comparing said message characteristic to routing criteria;
(f) delivering said mail message to said mailbox if said message characteristic corresponds with said routing criteria; and
(g) forwarding said mail message to said alternate electronic mail address if said message characteristic does not correspond with said routing criteria.

21. The method of claim 20, wherein said message characteristic is stored in header information of said electronic mail message.

22. The method of claim 21, wherein said message characteristic is stored in a message characteristic field of said electronic mail message.

23. A mail server for distributing electronic mail messages addressed for delivery to an electronic mail address of an electronic mailbox, the mail server comprising:
a central processing unit;
a memory operatively connected to said central processing unit;
a telecommunications device operatively connected to said central processing unit and capable of communicating via a communications network;
a first program stored in said memory and executable by said central processing unit for forwarding a first subset of said messages to an alternate electronic mail address; and
a second program stored in said memory and executable by said central processing unit for delivering a second subset of said messages to said mailbox.

24. The mail server of claim 23, further comprising:
a third program stored in said memory and executable by said central processing unit for receiving an electronic mail message addressed for delivery to said electronic mailbox;
a fourth program stored in said memory and executable by said central processing unit for identifying a message characteristic associated with said mail message;
a fifth program stored in said memory and executable by said central processing unit for comparing said message characteristic to routing criteria; and
a sixth program stored in said memory and executable by said central processing unit for delivering said message to said mailbox or forwarding said message to said alternate electronic mail address as specified by said routing criteria.

25. The method of claim 1, wherein said messages forwarded to said secondary address in step (a) are retrievable via a wireless messaging device.

26. The method of claim 1, further comprising the step of:
(c) forwarding a third subset of said messages to a tertiary electronic mail address.

27. The method of claim 26, wherein said third subset of messages forwarded to said tertiary ad dress in step (c) are retrievable via a wireless messaging device.

28. The method of claim 5, wherein step (g) comprises storing said message on a network appliance for retrieval via a user's mail client software, said network appliance being located and managed remotely.

29. The method of claim 5, wherein step (g) comprises storing said message on a network appliance for retrieval via a user's mail client software, said network appliance being located and managed locally.

30. The method of claim 5, wherein step (g) comprises storing said message on a network router, integrated as part of a Network Operating System (NOS) embedded in network router software.

31. The method of claim 5, wherein the step (g) comprises transmitting said message to a mail server.

32. The method of claim 31, wherein step (g) comprises display of said message to a said mail server.
